(19) United States
(12) Patent Application Publication
(10) Pub. No.: US 2016/0069994 A1
(43) Pub. Date: Mar. 10, 2016

(54) SENSE-AND-AVOID SYSTEMS AND METHODS FOR UNMANNED AERIAL VEHICLES

(71) Applicant: University of Kansas, Lawrence, KS (US)

(72) Inventors: Christopher Allen, Lawrence, KS (US); Lei Shi, Wichita, KS (US)

(21) Appl. No.: 14/843,714

(22) Filed: Sep. 2, 2015

Related U.S. Application Data
(60) Provisional application No. 62/048,165, filed on Sep. 9, 2014.

(51) Int. Cl. G01S 13/93; G01S 13/06

(52) U.S. Cl. CPC G01S 13/9303; G01S 13/06

(57) ABSTRACT

A sense-and-avoid system, for an unmanned air vehicle (UAV), configured to detect and estimate the relative position and velocity of a nearby object and to enable determination whether the nearby object poses a collision threat to the UAV. In one embodiment, the sense-and-avoid system is provided with a frequency modulated continuous wave (FMCW) synthesizer adapted to generate at least one swept-frequency waveform. The sense-and-avoid system may also be included with an RF subassembly. In some embodiments, the RF subassembly may include at least one transmit antenna adapted to transmit the at least one swept-frequency waveform. The at last one swept-frequency waveform may illuminate the nearby object. The sense-and-avoid system may be further provided with a plurality of receive antennas adapted to receive an echo signal from the nearby object. In some embodiments, the echo signal results from the illumination of the nearby object by the swept-frequency waveform. Additionally, the sense-and-avoid system may be provided with a signal processor configured to analyze the received echo signal and to derive object data for the nearby object. The object data may include at least range, radial velocity, and two-dimensional angle of arrival.

### CROSS REFERENCE TO RELATED APPLICATION

This application claims priority to U.S. Provisional Application No. 62/048,165, filed Sep. 9, 2014 and entitled “SENSE-AND-AVOID SYSTEMS AND METHODS FOR UNMANNED AERIAL VEHICLES,” the disclosure of which is incorporated herein in its entirety.

### GOVERNMENT INTEREST

This invention was made with government support under Grant NNX13AB76A, awarded by the NASA Aeronautics Research Institute LEARN Fund. The government has certain rights in the invention.

### TECHNICAL FIELD

The present disclosure relates to systems and methods for sense and avoidance of obstacles for Unmanned Aerial Vehicles (UAVs).

### BACKGROUND

UAVs are rapidly becoming commonplace in our skies. This is because UAVs are an enabling technology for valuable commercial and industrial services. Whereas manned aircraft rely on pilot acuity to avoid non-cooperative objects (e.g., towers, balloons, parachutists, etc.), UAVs require supplemental sensors for safe and reliable operation. However, UAVs generally do not have specialized equipment on board to sense and avoid other aircrafts (collision avoidance), or to sense and avoid static and fixed structures (obstacle avoidance). This deficiency results in a lack of situational awareness which poses unacceptable societal hazards and limits their utility.

One proposed idea to address this problem is to implement a network of ground-based sense-and-avoid radar systems to warn UAVs and other manned aircraft of potential hazardous/non-cooperative targets. These systems rely on a digital uplink between the ground and the cooperative aircraft. However, such a system has problems. For example, the uplink between the ground and the cooperative aircraft may be unreliable. In some instances, the uplink could be compromised or simply overburdened. Secondly, such systems are only as good as the ground-based coverage network, thereby requiring extensive ground resources and providing no help over extensive water flight paths.

To unlock the economic and societal benefits of UAVs, they must possess an acceptable level of situational awareness so as not to become a public safety hazard. Conventional types of collision avoidance systems are very expensive, complex, and prohibitively large and heavy for UAV applications, especially considering the spatial and temporal sensitivity required for UAV sense and obstacle avoidance. Therefore, integrating such a system on smaller vehicles is not entirely feasible. A need exists for a reliable and effective sense-and-avoid system for UAVs.

### BRIEF SUMMARY

The present application provides for systems and methods which provide for a sense-and-avoid system for a UAV, where the system is configured to detect and estimate the relative position and velocity of a nearby object, and to determine if the object poses a collision threat to the UAV. In one embodiment, a sense-and-avoid system is provided with a frequency modulated continuous wave (FMCW) synthesizer adapted to generate at least one swept-frequency waveform. The sense-and-avoid system may also be provided with an RF subassembly comprising at least one transmit antenna adapted to transmit at least one swept-frequency waveform. In some embodiments, the swept-frequency waveform illuminates the nearby object. Additionally, the RF subassembly may also comprise a plurality of receive antennas. Receive antennas in such plurality of receive antennas may be adapted to receive an echo signal from the nearby object. The echo signal may be a result of the illumination of the nearby object by the swept-frequency waveform. The sense-and-avoid system may also comprise a signal processor. The signal processor may be configured to analyze the received echo signal and may also derive object data for the nearby object using the echo signal. In some embodiments, the object data comprises at least range, radial velocity, and two-dimensional angle of arrival.

In further embodiments, the signal processor may be configured to generate a control signal that may be used to avoid a collision with a nearby object, or to compensate after UAV's maneuvers. Such a control signal may be provided to an onboard flight director which may direct the UAVs flight path, or may be communicated to ground resources to coordinate the UAV's flight path. In some embodiments, the control signal may include information about the nearby object.

In further embodiments, a method is provided to generate target objects reports. The method may comprise detecting object data, by a sense-and-avoid radar system, for a first target object. In some embodiments, the object data may comprise data of the first target object with respect to a UAV in six-degrees-of-freedom (6DoF). The 6DoF data may comprise at least range, azimuth, elevation, velocity in the range plane, velocity in the azimuth plane, and velocity in the elevation plane. The method may further comprise storing the object data for the first target object. In embodiments, the object data may be stored in on-board storage, or the object data may be transmitted off-board for storage. For example, the object data may be transmitted to ground resources. In some embodiments, object data for a second target object may be detected. The method may further comprise generating a target objects report. The target objects report may include at least the stored object data for the first target object, and in some embodiments may include the object data for the second target object. The 6DoF data may comprise at least range, azimuth, elevation, velocity in the range plane, velocity in the azimuth plane, and velocity in the elevation plane.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 illustrates an exemplary sense-and-avoid system for a UAV in accordance with an embodiment of the present application;

FIG. 2 illustrates a flow of operation of a radar system illustrating a method to sense-and-avoid uncooperative objects posing a collision threat to a UAV;

FIG. 3 illustrates a plot of frequency-domain signal matrix values illustrating the ability to discriminate object echo in range and Doppler from the direct-path leakage signal;

FIG. 4 illustrates a UAV-obstacle encounter requiring collision avoidance;

FIG. 5 illustrates a frequency vs. time graph of the frequency-swept transmit waveform, the received echo signal, and the dechirped mixed signal;

FIG. 6 illustrates multiple fast time samples aligned to create a fast-time, slow-time data matrix;

FIG. 7 illustrates theoretical vs. measured angle-of-arrival;

FIG. 8 illustrates angle-of-arrival error plot;

FIG. 9 illustrates maximum angle-of-arrival rate of change simulation; and

FIG. 10 illustrates data point and bit truncated 2-D FFT plot of a waveform generator simulated IF signal.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation. Likewise, the terminology used herein is for the purpose of describing particular embodiments only, and is not intended to limit the invention.

Systems and methods for sense and avoidance of obstacles for UAVs can be implemented in hardware, software, or a combination of hardware and software. When implemented in hardware, the systems and methods for sense and avoidance of obstacles for UAVs can be implemented using specialized hardware elements and logic. When portions of the systems and methods for sense and avoidance of obstacles for UAVs are implemented in software, the software can be used to control the various components of sense-and-avoid system of a UAV.

The software can be stored in a memory and executed by a suitable instruction execution system (microprocessor). The hardware portion of the systems and methods for sense and avoidance of obstacles for UAVs can include any or a combination of the following technologies, which are all well known in the art: discrete electronic components, a discreet logic circuit(s) having logic gates for implementing logic functions upon data signals, an application specific integrated circuit having appropriate logic gates, a programmable gate array(s) (PGA), a field programmable gate array (FPGA), etc.

The software for the systems and methods for sense and avoidance of obstacles for UAVs may comprise an ordered listing of executable instructions for implementing logical functions, and can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

Implementation of systems and methods, in accordance with embodiments of the present invention, to provide situational awareness for a UAV may involve a sense-and-avoid radar due to its capability and robustness. In some preferred embodiments, the systems and methods may operate on a UAV and may provide one or more of range, Doppler, and angle-of-arrival information of targets which might present a potential for a collision with the UAV. A two-dimensional (2-D) fast-Fourier transform (FFT) may be implemented on received radar echo signals to map targets of interest to a single range-Doppler cell. Additionally, phase differences in the target signal from an array of receiving antennas may be used to determine the target echo's three-dimensional angle-of-arrival.

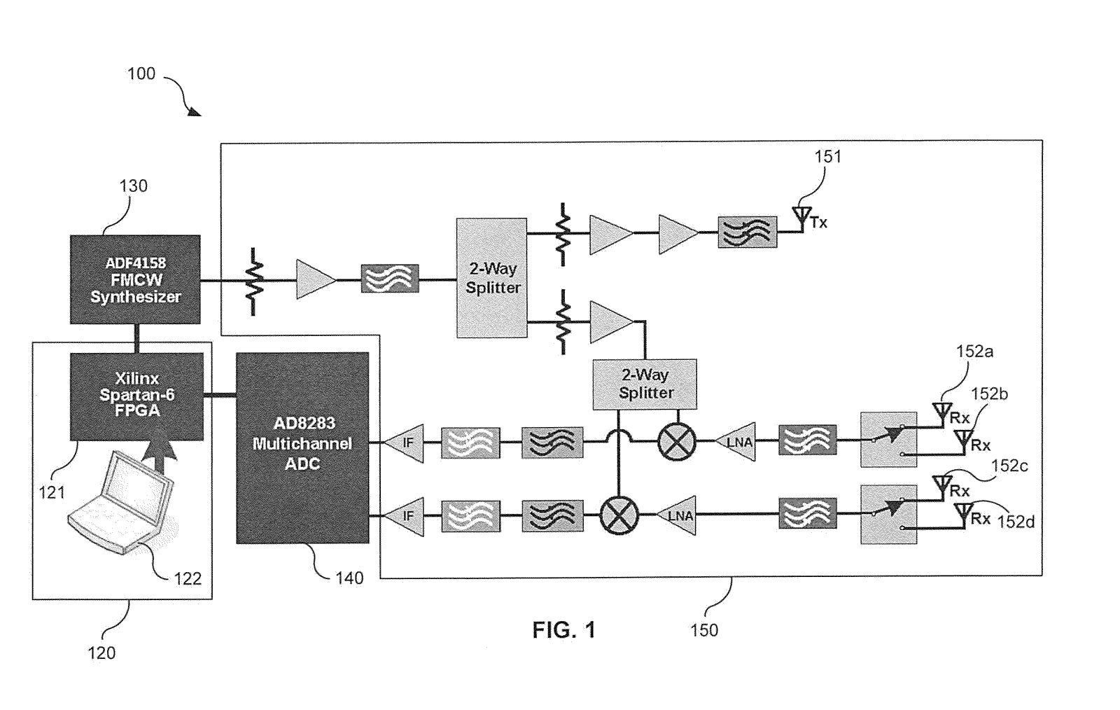

Systems and methods for sense and avoidance of obstacles for UAVs will now be described in the context of sense-and-avoid system 100 shown in FIG. 1. Sense-and-avoid system 100, which may also be referred to as radar system 100, may comprise a small, light-weight, low-power, multichannel, FMCW radar, and may detect and estimate the relative position and velocities of nearby objects (both mobile and fixed) that may pose a collision risk to UAVs. Radar system 100 may also comprise a transmit antenna 151 adapted to transmit at least one swept-frequency waveform to illuminate nearby objects, and may collect the echo signals from nearby objects via receive antennas 152a-152d. Radar system 100 may also comprise a signal processor 120 for signal and data analysis. In some embodiments, radar system 100 comprises at least four receiver antennas. From the received echoes, signal analysis may derive object data for each nearby object detected (e.g., the object's range, radial velocity, and two-dimensional angle of arrival). Analysis of the object data may be applied to reduce the false-alarm rate and to estimate the object's tangential velocity components.

In some embodiments, radar system 100 may incorporate programmable, radar-ready integrated circuits for FM signal generation and multichannel data acquisition, which may enable significant system miniaturization. Thus, radar system 100 may be miniaturized and automated to fly aboard a 50-lb UAV and may communicate information about nearby objects to an onboard flight director. In some embodiments, radar system 100's weight may be less than 2 lbs., may fit within a 2 in.×4 in.×6 in. volume, and may consume less than 10 W. Of course, a person of ordinary skill in the art would understand that radar system 100 may be implemented with other weight, size, and power consumption parameters sufficient to allow radar system 100 to fly aboard the a UAV having various requirements and capabilities.

Radar system 100 may comprise FMCW synthesizer 130. FMCW synthesizer 130 may comprise a waveform generator that may be configured to generate continuous, saw-tooth, frequency sweeps, also known as chirp signals. In some embodiments, the chirp signals may be centered about a particular frequency and may have a particular bandwidth to achieve a desired range resolution. For example, the chirp signals may be centered about 1.445 GHz with a bandwidth of 15 MHz, or may be centered about 2.3675 GHz. In some embodiments where a higher range resolution is desired, the bandwidth may be higher than 15 MHz. Modifications to a voltage controlled oscillator (VCO) and passive loop filter components of the FMCW synthesizer 130 may be made to meet chirp signal specifications. The waveform generator of FMCW synthesizer 130 may be driven by a clock (not shown). The clock may be internal or external. FMCW synthesizer 130 may also provide a MUXOUT signal, which pulses high at the start of each new waveform, allowing system synchronization.

Radar system 100 may also comprise analog-to-digital converter (ADC) 140. In some embodiments, ADC 140 may comprise an ADC with a 12-bit resolution and a multiplexer for input channels, but those skilled in the art would recognize that other resolutions may be used. ADC 140 may also comprise low noise amplifiers, programmable gain amplifiers, and anti-aliasing filters for each multiplexed channel. ADC 140 may be programmed through a serial port which controls the number of active channels, programmable gain and filter cutoff frequency. ADC 140 may also provide a DSYNC signal to indicate when the multiplexer has cycled back to channel 1.

Radar system 100 may comprise an RF subassembly 150. RF subassembly 150 may be assembled from connectorized components. In some embodiments, the connectorized components may be mounted on a plate. Such plate may be constructed from any number of conductive materials (e.g., aluminum, copper, etc.), and non-conductive materials (ceramic, composite polymers).

RF subassembly 150 may comprise a transmit chain and a receive chain. The transmit chain may comprise a number of RF amplifiers, attenuators, 2-way splitters, surface-acoustic wave (SAW) bandpass filters, and be adapted to amplify the radar transmit chirp signal power. In some embodiments, the transmit chain may be adapted to amplify the radar transmit chirp signal power to 25.5 dBm at transmit antenna 151.

The receive chain may comprise a number of low-noise-amplifiers, intermediate frequency (IF) filters, SAW bandpass filters, RF frequency mixers, attenuators, 2-way splitters, op-amps, high-pass filters, and be adapted to collect the echo signals from nearby objects via any pair of receive antennas 152a-152d. Components in the receive chain may be adapted to handle the power of the leakage signal (the strongest received signal expected from antenna 151). In some embodiments, SAW bandpass filters used in the transmit and receive chain may be adapted to operate at a center frequency of 1.445 GHz, and may be used to filter out spurious signals in both the transmit and receive chains.

In some embodiments, transmit antenna 151 may be an omnidirectional antenna that may operate at various frequencies and may be mounted externally, or internally, on the UAV. In other embodiments, transmit antenna 151 may be a vertically polarized, commercial off-the-shelf (COTS), monopole antenna that may operate at various frequencies. In some embodiments, the various frequencies may include the center frequency about which the chirp signals generated by FMCW synthesizer 130 are centered. For example, the various frequencies may be between 1-3 GHz. In other embodiments, higher or lower frequencies may be used, depending on the frequencies used by FMCW synthesizer 130. In some embodiments, transmit antenna 151 may be encased in a dome (not shown.) The dome may be made of any number of materials including plastic, PVC, or any material capable of being adapted to protect transmit antenna 151.

In some embodiments, receive antennas 152a-152d may be configured as any number of arrays. In one embodiment, receive antennas 152a-152d may be configured as an array of four low-gain receive antennas and may enable unique determination of each detected object's azimuth and elevation positions relative to the UAV's frame of reference. In alternative embodiments, receive antennas 152a-152d may be provided as subarrays comprised of antenna pairs for target echo angle-of arrival estimation using phase differences.

By using a relative signal phase for each pair of receive antennas 152a-152d, embodiments of the present invention eliminate the need for antenna scanning while providing the required spatial coverage. Receive antennas 152a-152d may be polarized antennas, adapted to gather data to be used in calculating range and Doppler measurements. In some embodiments, receive antennas 152a-152d may be mounted on the UAV so as to optimize their reception. For example, in some embodiments at least one of receive antennas 152a-152d may be a monopole antenna provided above a common circular ground plane to measure angle-of-arrival in the azimuth plane, and at least one antenna may be a quarter-wave dipole antenna aligned vertically for measuring angle-of-arrival in the elevation plane. In other embodiments, at least one subarray comprised of at least one antenna pair may be used to measure the angle-of-arrival in the azimuth plane, and at least one subarray comprised of at least one antenna pair may be used to measure the angle-of-arrival in the elevation plane. By measuring the phase difference between the echo signals received at each antenna of a pair, each angle-of-arrival, for each plane, may be measured.

Radar system 100 may also comprise signal processor 120. Signal processor 120 may provide digital controls, synchronization, and signal processing. Signal processor 120 may further comprise Field Programmable Gate Array (FPGA) 121 and a user terminal 122. In some embodiments, FPGA 121 may provide clock signals to both FMCW synthesizer 130 and ADC 140, and may utilize the MUXOUT and DSYNC signals to trigger a fast-time fast-Fourier transform (FFT) process. In some embodiments, signal processing may be performed entirely by FPGA 121. In other embodiments, signal processing may be split between FPGA 121 and another device in order to reduce the memory storage requirements of FPGA 121, due to limited on-chip memory constraint of FPGA 121. For example, in some embodiments, signal processing may be split between FPGA 121 and a user terminal 122. Even with splitting, off-chip memory may be needed to fully process all receive channels simultaneously. FPGA 121 may also communicate with user terminal 122 via USB for data storage and analysis.

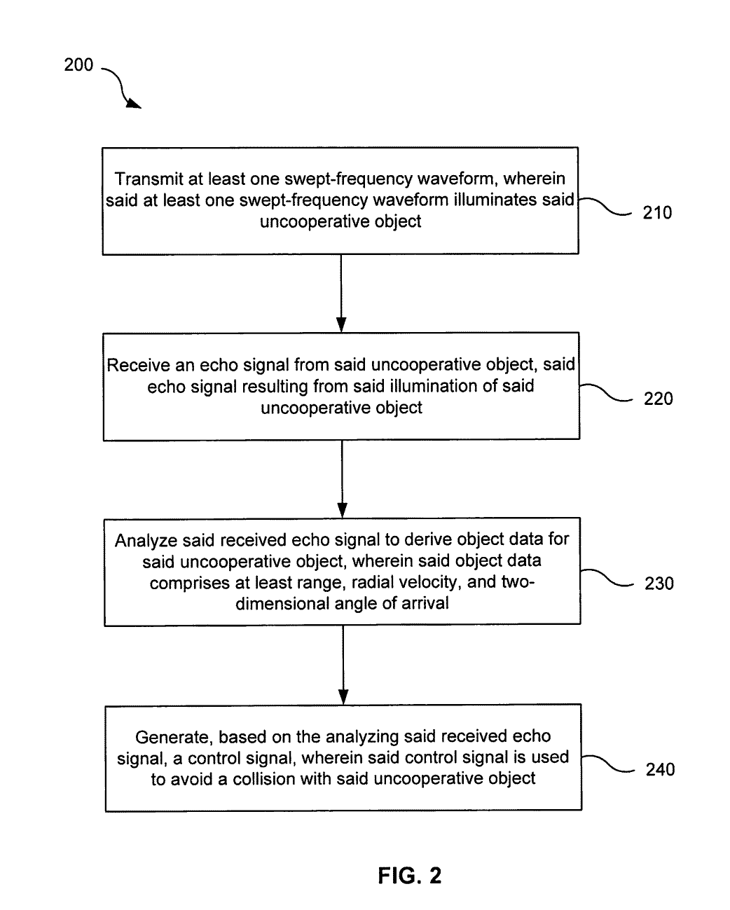

Having described the illustrative configurations of sense-and-avoid system 100, attention is directed to FIG. 2 showing a flow of operation of radar system 100 illustrating method 200 to sense-and-avoid uncooperative objects posing a collision threat to a UAV. Method 200 begins at block 210 with transmitting at least one swept-frequency waveform. The at least one swept-frequency waveform may illuminate the uncooperative object. The illumination of the uncooperative object by the at least one swept-frequency waveform may generate an echo signal. At block 220, the echo signal, which may be a result of the illumination of the uncooperative object, is received. Then, at block 230, the received echo signal is analyzed to derive object data for the uncooperative object. The object data may comprise at least one of range, radial velocity, or two-dimensional angle of arrival.

At block 240, a control signal is generated based on the analysis of the received echo signal. In some embodiments, the control signal may include the object data derived at block 230. The control signal may also be used to determine whether the uncooperative object poses a collision threat to the UAV. In some embodiments, the control signal may be communicated to an onboard flight director, or communicated to ground resources. In such embodiments, the determination as to whether the uncooperative object poses a collision threat to the UAV may be made by the onboard flight director, or may be made by ground resources.

Extensive analysis and simulation using a morphing potential field formulation regarding collision avoidance, obstacle avoidance, and trajectory following for fixed-wing, high-speed, high-inertia UAVs shows that a radar sensing range of only 1000 ft (˜300 m) may give sufficient reaction time to execute avoidance maneuvers providing clearance for static obstacles and vehicle-to-vehicle encounters. Application of these findings to lower-speed, lower-inertia class of fixed-wing UAVs reduces further the required detection range (for even large, fast intruder aircraft) to about 100 m if using adaptive avoidance logic and intelligent decision making.

As described above, radar system 100 may employ multichannel, FMCW radar. FMCW radar operates by constantly transmitting swept-frequency signals while simultaneously receiving target echoes. This simultaneous transmitting and receiving permits a large time-bandwidth product which lowers the requirements on transmit power, but might create a leakage signal resulting from the direct radiating path between the transmitter and receiver, which makes integration of a FMCW radar into a UAV a challenge.

In some embodiments, the proposed transmit power of radar system 100 may be 1 W. The received signal power, Pᵣ, is given by the radar system 100 range Equation 1.

Pᵣ=PₜGₜGᵣλ²σL/(4π)³R⁴ (Equation 1)

Where Pₜ is the transmit power, Gₜ and Gᵣ are the gains of the transmit and receive antennas, λ is the wavelength at the center frequency, σ is the target's radar cross section (RCS), L represents various losses, and R is the range to the target.

Data gathered over multiple transmit cycles during a 100-ms time frame may be organized into a data matrix. Columns of the data matrix may represent data captured during a single 200-μs transmit signal, and adjacent columns may represent subsequent transmit signals. The columns of this data matrix may be referred to as the fast time data while rows of this data matrix may be referred to as the slow time data.

Harming windowing and FFTs may be performed across each of the columns of the data matrix (fast time FFTs) and then across each row (slow time FFTs). The resulting two-dimensional (2-D) FFT data matrix may be the range and Doppler pulse compressed radar image. The target may be mapped to a specific range and Doppler cell based on its distance and relative radial velocity to radar system 100. The detected target signal may be a complex value with a magnitude and phase that varies based on the target's relative range to each individual receive antennas 152a-152d. Utilizing the phase difference, the angle-of-arrival of the target echo may be calculated.

In one specific example of radar system 100, which a person of ordinary skill in the art would recognize as not limiting the broader claimed invention herein, analysis and simulation of FMCW radar assumes the parameters listed in Table 1 below, where the pulse repetition interval (PRI) is the fast-time period and the effective pulse repetition interval (EPRI) includes multiple fast-time periods that constitute a slow-time period.

TABLE 1
Assumed FMCW Radar Parameters

| Parameter | Value | |
|---|---|---|
| PRI | 200 | μs |
| EPRI | 100 | ms |
| Center Frequency | 1.445 | GHz |
| Bandwidth | 15 | MHz |
| Tx Power | 1 | W |
| Sampling Frequency | 4 | MHz |
| (per channel) | | |

In this example, the total time-bandwidth product of the 2-D FFT yields a theoretical SNR improvement of 61.7 dB. Experimental results show that the N-coherent integrations, where N is the number of points in the data matrix (800×500), increases the dynamic range by 56 dB.

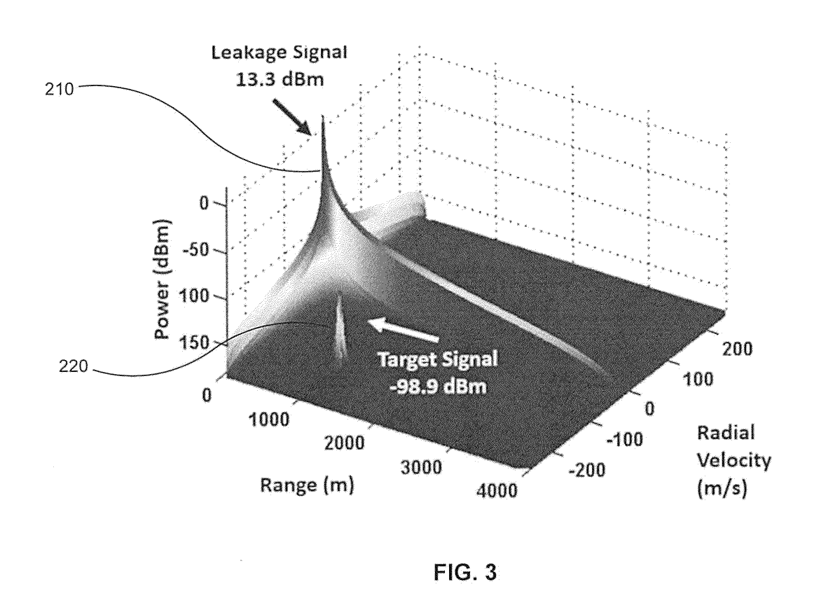

As can be seen in FIG. 3, the 2-D FFT process for this example maps the target and leakage signals into different range and Doppler cells when plotted on a 2-D graph. As can be seen, the 13.3 dBm leakage signal 210 is the stronger of the two peaks. Given the fixed and close proximity of transmit antenna 151 and receive antennas 152a-152d, this process maps the leakage signal to near zero range and zero Doppler, resulting in sidelobes that overwhelm these zero-value axes even after windowing.

The zero range and zero Doppler axes however, represent targets that are either already too close to be avoided or are maintaining a constant distance with zero relative velocity (flying in unison) in which case a collision will never occur.

For other targets, such as a target 1 m² RCS that are not too close and not flying in unison with the radar system, a target signal 220 may appear as impulses offset from the zero range and Doppler axes after the 2-D FFT, as shown in FIG. 3.

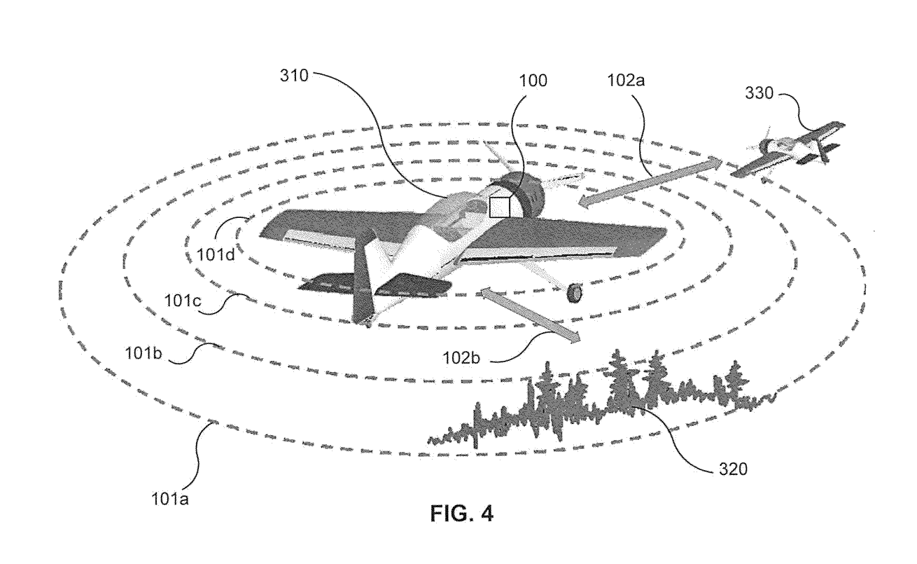

During operation, radar system 100, shown mounted in UAV 310 in FIG. 4, may repeatedly illuminate all nearby objects (e.g., ground obstacle 320 and airborne obstacle 320) simultaneously with low-power swept-frequency waveforms 101a-101d. In some embodiments, the duration of the frequency sweep may exceed the round-trip travel time associated with the ranges of interest, and thus, echo signals 102a and 102b may be received at receive antennas 152a-152d while radar system 100 is still transmitting. This transmitter illumination of the receive antennas may create a direct-path leakage, whose effects may be managed in signal processing.

In some embodiments where multiple radar-equipped UAVs operate asynchronously at ranges where interference can result, swept-frequency waveforms 101a-101d may be uniquely coded so that waveforms originating from other UAVs can be rejected during signal processing in order to avoid ambiguities. In some embodiments, the starting phase of swept-frequency waveforms 101a-101d may be varied on a sweep-by-sweep basis within an observation period such that waveforms originating from other UAVs may appear (after signal processing) beyond the Doppler frequencies of interest.

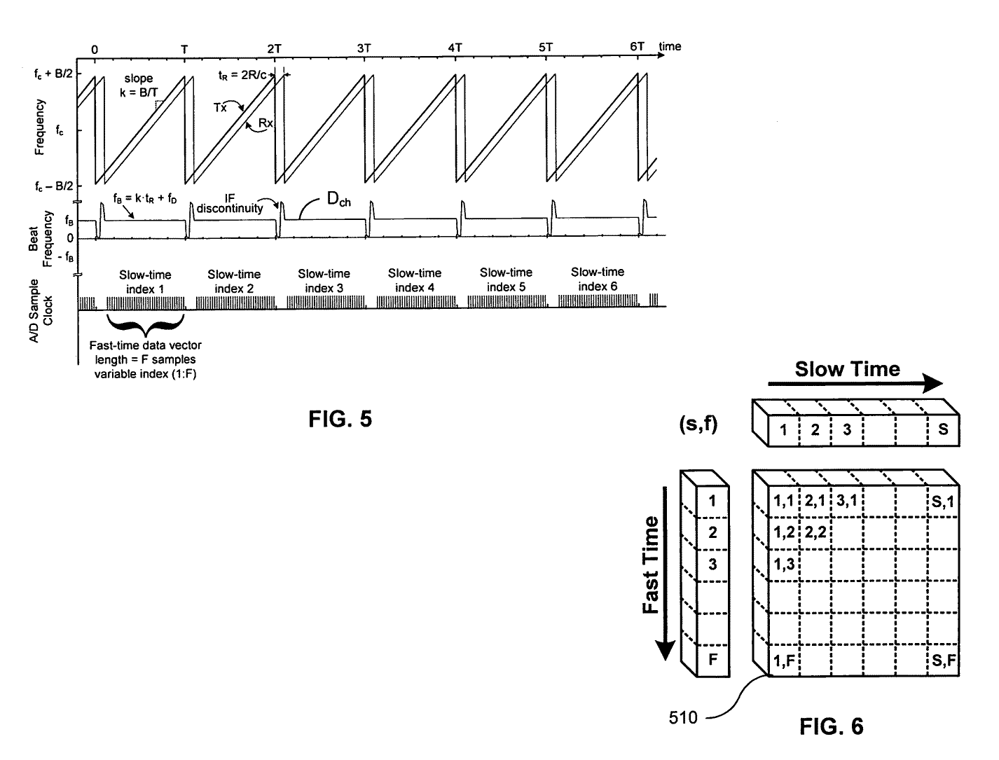

As shown in FIG. 5, in embodiments, during transmission of a swept-frequency waveform Tₓ, a received echo signal Rₓ may be mixed with swept-frequency waveform Tₓ being transmitted (and lowpass filtered) to produce a dechirped signal D_{ch} whose duration may match that of the transmitted swept-frequency waveform Tₓ. Dechirped signal, which may be in the fast-time domain, may be recorded as a real-valued signal vector.

As subsequent dechirped signals, from subsequent received echo signals for subsequently transmitted swept-frequency waveforms, may be recorded, each dechirped signal producing unique signal vectors in fast time, they are stored side-by-side forming a time-domain signal matrix 510, as shown in FIG. 6, whose domains are termed fast time and slow time.

In some embodiments, a two-dimensional spectral analysis of signal matrix 510 may decompose the time-domain received echo signal Rₓ (as shown in FIG. 5) into a complex, frequency-domain signal, expressed in terms of beat frequency, which may be analogous to range, and Doppler frequency, which may be analogous to radial velocity, resulting in a frequency-domain signal matrix. In some embodiments, the frequency-domain signal matrix may be truncated so that it may contain only the beat and Doppler frequencies of interest. Object detection may be declared when the signal energy level within the truncated frequency-domain signal matrix exceeds a given threshold level. This spectral analysis allows accurate real-time range and Doppler (range rate of change) estimation.

As discussed above, transmitter illumination of the receive antennas may create a direct-path leakage. In some embodiments, energy from the direct-path leakage may be mapped to proximate ranges and with negligible Doppler. In the sense-and-avoid mission scope, nearby targets with negligible Doppler pose no collision threat and may therefore be ignored. Signal matrix 510 may be conditioned (windowed) prior to spectral analysis to prevent the spectral leakage from the direct-path leakage from obscuring echo signals from nearby objects. As a result the residual spectral leakage may obscure only regions within the frequency-domain signal matrix corresponding to negligible Doppler as well as regions proximate to the radar. Thus, in some embodiments, these regions may be excluded from the detection process.

As noted above, by analyzing each receive antenna's 152a-152d relative signal phase, receive antennas 152a-152d enable unique determination of each detected object's azimuth and elevation position relative to the UAV's frame of reference, with no antenna scanning required. The relative detected object's azimuth and elevation positions may be arranging the receive antennas in pairs, and adapting at least one of the pairs to detect relative azimuth, and at least one pair to detect relative elevation. For example, where four receive antennas are used, the four antennas can be arranged into a first pair and a second pair, the first adapted to detect the detected object's azimuth relative to the UAV, and the second pair adapted to detect the relative elevation. The relative azimuth of the detected object may be obtained by comparing the received echo signals received at each antenna of the azimuth antenna pair. Similarly, the relative elevation of the detected object may be obtained by comparing the received echo signals received at each antenna of the elevation antenna pair antenna. In this manner, antenna scanning does not have to be performed.

In some embodiments, the relative signal phase information may be obtained by comparing the complex values at the object's range and Doppler position within each receive antenna's frequency-domain signal matrix. For modest speed objects at the ranges of interest the angular position rate of change may be sufficiently low that may not require re-measurement during each observation period. In this case, the relative signal phase analysis can be performed on alternating antenna pairs during sequential observation periods while maintaining a required angular accuracy.

In some embodiments, the number of signal processing channels may be less than the number of receive antennas, provided that radio-frequency switches are used that enable a selected antenna be connected to a signal processing channel during a specified observation period.

For each detected object, a detection data record containing the object's relative position (range, azimuth angle, and elevation angle), echo energy level and signal-to-noise ratio, and its radial velocity may be created. Auxiliary measures received from on-board navigation systems may also be included in the detection data record and may include time, UAV position, velocity, and attitude (roll, pitch, yaw).

In some embodiments, time-series analysis of detection data may be applied to eliminate false objects and to estimate the object's tangential velocity components. Rejection of false object detections (e.g., from measurement artifacts, spurious data, ground clutter) may permit a lower object-detection threshold that may effectively boost the system sensitivity without increasing the false-alarm rate. By estimating the object's tangential velocity components radar system 100 may provide object data having six degrees of freedom (three position measures [x, y, z] and three velocity measures [vₓ, v_{y}, v_{z}]) thus enabling short-term object position prediction via extrapolation.

### Example Embodiment

In another example embodiment, a sense-and-avoid system may be flown on a UAV surrogate to detect uncooperative objects, such as intruder aircraft. For example, the example sense-and-avoid system may be flown in a piloted Cessna C172, and candidate intruder aircraft may include a 40% Yak-54 UAV (as shown in FIG. 1). Those skilled in the art will appreciate that other manned and unmanned general-aviation aircraft may be used as intruder aircraft and as a UAV surrogate. In embodiments, the example sense-and-avoid system may be implemented to detect a potentially hazardous stationary structure (e.g., a radio tower). In other embodiments, the example sense-and-avoid system may be miniaturized and installed on a 40% Yak-54 UAV. The 40% Yak-54 UAV is a radio controlled, commercial off-the-shelf (COTS) hobby-grade aircraft that has been equipped with an autopilot and telemetry instrumentation, which may be primarily used for training and research. Table 2 lists the specifications of this UAV.

TABLE 2
40% Yak-54 UAV Specifications

| Parameter | Value | |
|---|---|---|
| Wingspan | 3.1 | m |
| Length | 3.1 | m |
| Empty Weight | 18.1 | kg |
| Payload | 4 | kg |
| Cruise speed (max) | 36 | m/s |

Some embodiments may involve the Cessna C 172 carrying the example sense-and-avoid system at a cruising speed of 54 m/s (120 mph) with an altitude of no less than 150 m (500 ft) above ground level (AGL). Embodiments may also involve the intruder UAV cruising at a maximum height of 120 m (400 ft) AGL, with a minimum RCS of the intruder UAV estimated to be 1 m².

Table 3 lists the sensor requirements sought to be achieved by embodiments of the example sense-and-avoid system example. The sensor's range requirements may be determined by the aircraft's performance characteristics (e.g. agility) and the autopilot algorithms (e.g. Extended Kalman Filter). Simulations generated by The University of Kansas (KU) Aerospace Engineering (AE) department have shown that detection within 300 to 800 meters is sufficient for air-collision avoidance by the 40% Yak-54 UAV (the radar system's target platform in the subsequent phases) assuming the worst case scenario of a head on collision with another 40% Yak-54 UAV both traveling at maximum cruise speed.

TABLE 3
Sensor Requirements

| Parameter | Value | |
|---|---|---|
| Detection Range | 300-800 | m |
| Field of View | 360° | azimuth |
| | ±15° | elevation |
| Range Resolution | 10 | m |
| Doppler Resolution | 10 | Hz |
| Angular Resolution | ±3° | |
| Miniaturized Radar Weight | <4 | kg |
| Miniaturized Radar Size | 20 × 15 × 10 | cm (approx.) |
| Power Consumption | 19.95 | W |

In some embodiments, the combined digital hardware (FMCW synthesizer, ADC, and FPGA) may consume 4.95 W during operation. However, those skilled in the art would appreciated that power consumption of the combined digital hardware may be less or more than 4.95 W. For example, in other embodiments, the combined digital hardware may consume less than 10 W during operation.

The FMCW synthesizer may require fine tuning of the loop filter and digital settings to produce a usable, continuous, saw-tooth frequency ramp. By modifying the loop filter components, the spectrum of the chirp signals may be cleaned and may show a span of 15-MHz bandwidth centered at 1.445 GHz. This may be within a frequency band set aside for aeronautical telemetry. It should be appreciated by those skilled in the art that in some embodiments, a bandwidth greater than 15 MHz may be used when higher range resolution is desired, and the chirp signals may be centered at a different frequency from 1.445 GHz (e.g., 2.3675 GHz).

In some embodiments, nonlinearities in frequency up-chirp may cause the pulse-compressed signals to broaden in the range axis as time delay, or target range, increases. From a time-domain perspective, it may take roughly 30-40 μs after the end of a chirp for the device to settle and begin a new chirp waveform. This may prompt the implementation of a 50-μs pause in data acquisition between chirps while waiting for the frequency synthesizer to steady. This pause may effectively reduce the time-bandwidth product of the radar system. However, the FPGA may utilize the pause to perform FFTs on the previous fast time data set eliminating the need for multiple buffers, relaxing the FPGA memory constraints.

In embodiments, the multiple integrated functionalities of the ADC may greatly simplify the receiver design after the IF down-conversion. The variable gain amplifier may be set to the default 16 dB gain, but other gains may be used to achieve the most stable output. However The ADC's 12-bit output may be in an offset binary format where an input of 0 V is ideally digitized to ‘100000000000’. In other embodiments, each channel of the ADC may be slightly off from this value and the offset may vary slightly channel to channel. In the example sense-and-avoid, the ADC may introduce noise, which may be visible even after the 2-D FFT.

In the example embodiment, the total transmit chain gain may be 34.5 dB, which may result in a transmit power of 27 dBm. Of course, it should be appreciated that other transmit chain gains may be achieved. The receiver gain may be 6.65 dB (not including the amplifiers built into the ADC), but it should be appreciated that other receiver gains may also be achieved. In some embodiments, there may be a leakage between the transmit chain and the receiver chain. For example, with a −39 dB of transmit-to-receive antenna coupling (based on in-plane measurements) the leakage signal strength may be −5.35 dBm after the IF down conversion just before the input into the ADC, and this may not saturate the example sense-and-avoid system. In embodiments, the total noise figure for the RF subassembly may be 5.73, and the RF subassembly may consume 15 W. It should be appreciated that the total noise figure for the RF subassembly may be higher or lower, and the power consumption of the RF subassembly may be less or more than 15 W. For example, in other embodiments, the power consumption of the RF subassembly may be less than 10 W during operation.

Receive antennas were tested in simulations an anechoic chamber. Anechoic chamber measurements of azimuth monopole antennas show that the antennas are suitable for the FMCW radar system of example embodiments, with a reflection coefficient of −18.3 dB at 1.445 GHz and a best case scenario of −23 dB at 1.4 GHz. The more concerning issue was determining the ability to produce accurate angle-of-arrival estimates. After phase unwrapping the received signals from the azimuth monopole array, a correlation was observed between the calculated and theoretical angles of arrival.

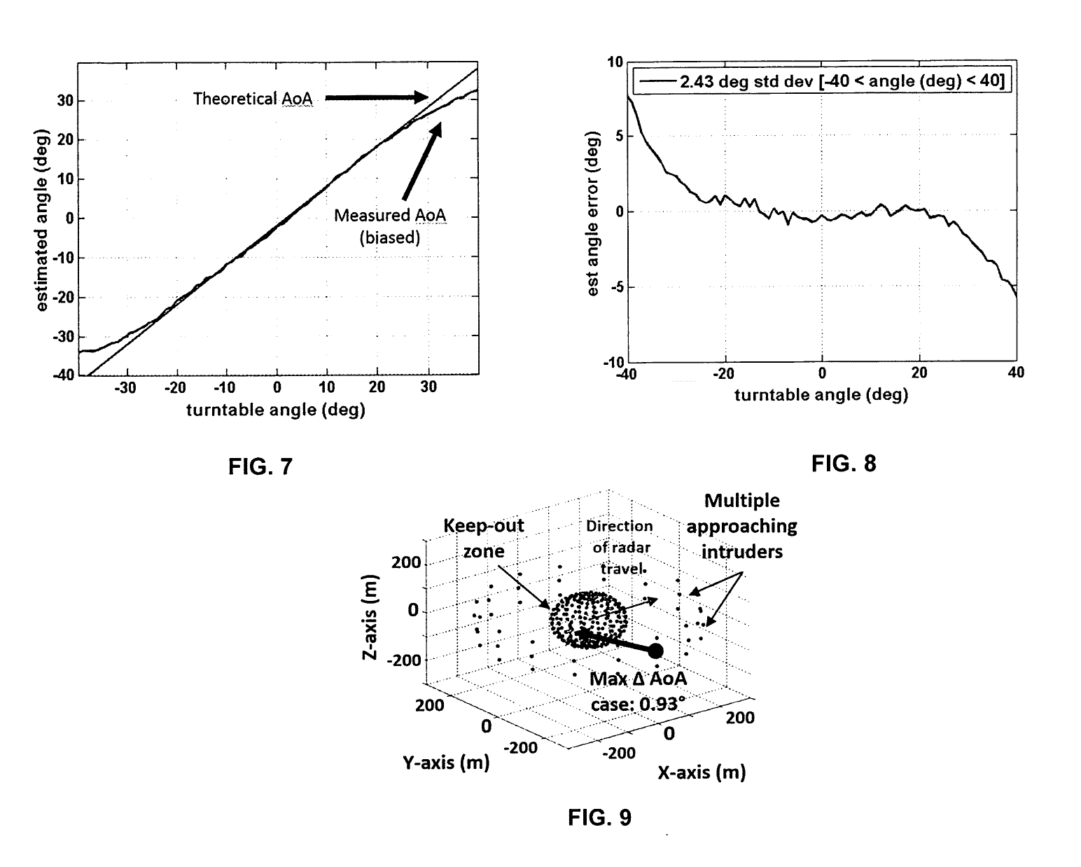

A more in-depth analysis of the angle-of-arrival (AoA) was performed on the elevation antenna pair where the relationship between the theoretical and calculated results were investigated. It was discovered that applying a bias to the relative antenna spacing caused extremely strong correlation between the theoretical and measured results with a standard deviation of 2.43° over a ±40° field of view (far greater than the ±15° elevation view angle requirement), as can be seen FIGS. 7 and 8.

In addition to the AoA error analysis, simulations were performed to determine the worst case expected AoA rate of change per EPRI. Trajectories of approaching intruders from a range of 300 meters (within the ±15° elevation viewing angle) towards a 100-meter keep-out zone surrounding the radar were simulated with the assumption that both the radar and target were moving at 36 m/s (speed of the 40% Yak-54 UAV). The largest AoA rate of change was found to be from a target located on an orthogonal axis to the radar's direction of travel with a trajectory that is tangential to the rear of the keep-out zone, as shown in FIG. 9. For this case, the maximum angle-of-arrival rate of change during a single EPRI (100 ms) was found to be 0.93°.

The results shown in FIG. 9 indicate that in the real-time system, AoA estimation is not necessary on every EPRI since its maximum rate of change is less than the ±3° accuracy requirement. This will allow the signal processor more time (up to 3 EPRIs) to perform the estimate which could be a time consuming task.

The signal processor performance requirement is twofold. First it must be fast enough to meet the demand of real-time processed results. Secondly it must be capable of detecting the target without ambiguity (generally a 10 dB SNR requirement).

The FPGA, clocked at 100 MHz, was able to perform a fixed point, 16-bit wide, 1024-point, FFT in approximately 34 μs. This was less time than it took to gather all of the data for the next set of FFTs and thus in the fast-time dimension, continuous real time FFTs were performed. Upon proper implementation of an external memory, ping ponging two data matrices per radar channel may allow data collection to continue while the slow-time FFTs are being calculated for the previous data matrix, thus allowing continuous slow-time dimension processing as well.

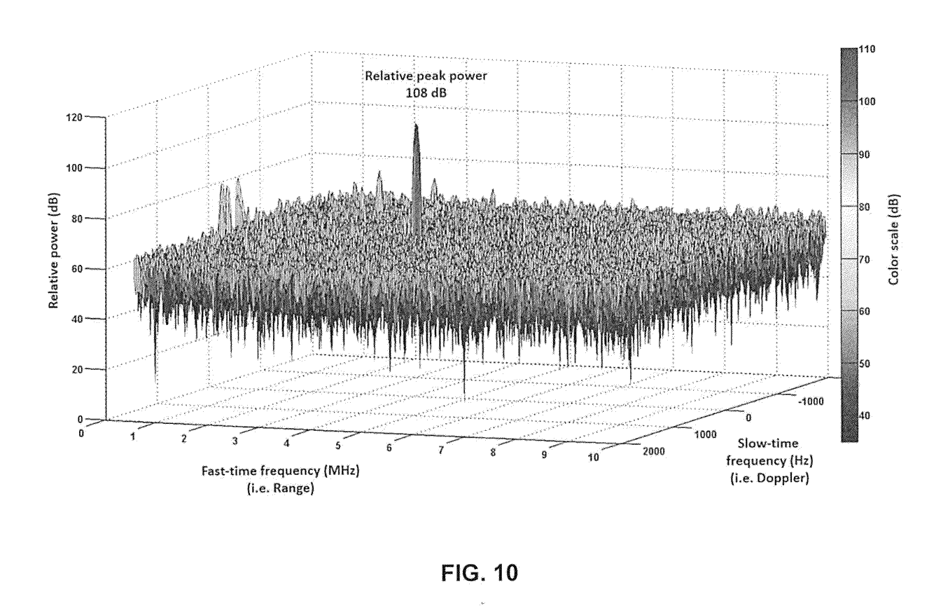

FIG. 10 shows an example of a 2-D FFT result generated by the signal processor for a simulated target IF signal of −75 dBm. Since the IF radar signal of FIG. 9 was simulated using a function generator, there was no Doppler component and thus the target impulse is located on the zero Doppler axis. Additionally, there was no leakage signal either, and therefore, the target signal is not overwhelmed by the leakage signal's side-lobes.

The range axis of the plot ranges from 50 kHz to 1 MHz (100 to 2000 m). By blanking out the first 100 meter range nearest to the radar, the excess dynamic range occupied by the leakage signal was reallocated to the much weaker target signals. This process was done immediately after each fast-time FFT where the 0-50 kHz IF frequency band (0-100 m range) was removed. As a result, the remaining data had a large portion of the most significant bits unused and was removed as well. In total, the 27-bit wide unsealed FFT was truncated down to the least significant 16 bits after removal of the leakage signal and the total 1024 points was reduced to 256 points. Though not shown, a similar process of reducing the number of points could be performed in the slow-time axis.

The −75 dBm signal in FIG. 10 was fairly large and was clearly seen from the results of the 2-D FFT. The other spurious spikes are the results of the coherent noise from the bench top waveform generator used to simulate the target IF frequency.

Although the embodiments of the present disclosure and their advantages have been described in detail, it should be understood that various changes, substitutions and alterations can be made herein without departing from the spirit and scope of the disclosure as defined by the appended claims. For example, while the embodiments discussed above are in the context of radar systems and antennas, the inventive concepts may be implemented in ultrasonic systems (utilizing acoustic transmissions and reflections as opposed to electromagnetic) having transducers which send/receive signals in place of antennae. Such applications would likely have shorter-range applications and may have other bandwidth limitations with respect to electromagnetic communications. However, such embodiments may be useful in selected applications where these considerations can be addressed.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A sense-and-avoid system for an unmanned air vehicle (UAV), said system configured to detect and estimate the relative position and velocity of a nearby object, said system comprising:
at least one transmit antenna adapted to transmit at least one swept-frequency waveform, wherein said at least one swept-frequency waveform illuminates said nearby object;
a plurality of receive antennas adapted to receive an echo signal from said nearby object, said echo signal resulting from said illumination of said nearby object; and
a signal processor configured to analyze said received echo signal and to derive object data for said nearby object, wherein said object data comprises at least range, radial velocity, and two-dimensional angle of arrival.

2. The sense-and-avoid system of claim 1, wherein said object data is derived by comparing the received echo signals received at at least two antennas in said plurality of receive antennas, whereby antenna scanning is not performed.

3. The sense-and-avoid system of claim 2, wherein said plurality of receive antennas comprises at least four receive antennas adapted to detect said two dimensional angle of arrival data for said nearby object, said four receive antennas arranged into a first pair and a second pair, said first pair adapted to detect azimuth data for said nearby object, and said second pair adapted to detect elevation data for said nearby object.

4. The sense-and-avoid system of claim 1, wherein the signal processor is further configured to generate, based on the analysis of said echo signal, a control signal including said object data.

5. The sense-and-avoid system of claim 4, wherein said control signal is communicated to an onboard flight director.

6. The sense-and-avoid system of claim 4, wherein said control signal is communicated to a ground resource.

7. The sense-and-avoid system of claim 1, wherein said sense-and-avoid system is configured to be used in a UAV having a less than 4 kilogram payload capacity

8. A method to sense-and-avoid an uncooperative object posing a collision threat to an unmanned air vehicle (UAV), said method comprising:
transmitting, by a radar system, at least one swept-frequency waveform, wherein said at least one swept-frequency waveform illuminates said uncooperative object;
receiving, by said radar system, an echo signal from said uncooperative object, said echo signal resulting from said illumination of said uncooperative object;
analyzing, by said radar system, said received echo signal to derive object data for said uncooperative object, wherein said object data comprises at least range, radial velocity, and two-dimensional angle of arrival.

9. The method of claim 8, further comprising:
generating, based on the analyzing said received echo signal, a control signal, wherein said control signal includes said object data.

10. The method of claim 9, wherein said control signal is communicated to an onboard flight director.

11. The method of claim 9, wherein said control signal is communicated to a ground resource.

12. The method of claim 8, wherein said radar system is configured to be used in a UAV having a less than 4 kilogram payload capacity.

13. A method to generate target objects reports, said method comprising:
detecting object data, by a sense-and-avoid radar system, for a first target object, said object data comprising data in six-degrees-of-freedom (6DoF) of said first target object with respect to an unmanned aerial vehicle (UAV);
storing said object data for said first target object; and
generating a target objects report, said target objects report including at least said stored object data for said first target object;
wherein said 6DoF data comprises at least range, azimuth, elevation, velocity in the range plane, velocity in the azimuth plane, and velocity in the elevation plane.

14. The method of claim 13 further comprising:
detecting object data for a second target object, said object data comprising at least spatial data and rate data of said second target object with respect to said UAV, wherein said target objects report further includes at least said stored object data for said second target object.

15. A sense-and-avoid system for an unmanned air vehicle (UAV), said system configured to detect and estimate the relative position and velocity of a nearby object, said system comprising:
at least one transmission means adapted to transmit at least one swept-frequency waveform, wherein said at least one swept-frequency waveform illuminates said nearby object;
a plurality of receiver means adapted to receive an echo signal from said nearby object, said echo signal resulting from said illumination of said nearby object; and
a signal processor configured to analyze said received echo signal and to derive object data for said nearby object, wherein said object data comprises at least range, radial velocity, and two-dimensional angle of arrival.

16. The system of claim 15 wherein the at least one transmission means and plurality of receiver means transmits and receives at least one of acoustic or electromagnetic data.
